(19) United States
(12) Patent Application Publication
(10) Pub. No.: US 2012/0037402 A1
(43) Pub. Date: Feb. 16, 2012

(54) ELECTRIC WIRE HOLDER

(75) Inventor: Harumi Kawase, Shizuoka (JP)

(73) Assignee: YAZAKI CORPORATION, Tokyo (JP)

(21) Appl. No.: 13/266,214

(22) PCT Filed: Nov. 30, 2010
(86) PCT No.: PCT/JP2010/071373

§ 371 Date: Oct. 25, 2011

(30) Foreign Application Priority Data
Dec. 1, 2009 (JP) 2009-273398

(51) Int. Cl. H01B 7/00

(52) U.S. Cl. 174/135

(57) ABSTRACT

An object of the invention is to provide an electric wire holder capable of facilitating an end treatment of a wiring harness to reduce the fabrication cost of the wiring harness and of increasing the reliability in the insulation displacement connection at the end portion of the wiring harness. In an electric wire holder 1 including a holder main body 5 which holds a plurality of electric wires 3 in parallel with an electric wire alignment portion 11 and a holder cover 6 which sandwiches portions 3a of the electric wires 3, which are led out from the holder main body 5 together with the holder main body 5, the electric wire alignment portion 11 is formed with a plurality of leading end insulation holes 14 through which leading end portions 3b of the electric wires 3 are inserted so that the electric wires 3 are positioned in parallel and an insulation displacement blade insertion hole 15 through which an insulation displacement blade 31 is inserted from the outside. Each of the leading end insertion holes 14 is formed into a tapered-shape which satisfies D2≦d<D1, where D1 denotes an inside diameter of each of the leading end insertion holes 14 at an electric wire lead-in side, D2 denotes an inside diameter of each of the leading end insertion holes 14 at an electric wire lead-out side, and d denotes an outside diameter of a sheathing of each of the electric wires 3.

### TECHNICAL FIELD

The present invention relates to an electric wire holder capable of facilitating an end treatment of a wiring harness by being attached to an end portion of the wiring harness in place of an insulation displacement connector to reduce the fabrication cost of the wiring harness.

### BACKGROUND ART

In general, a wiring harness that is routed in a vehicle is configured so as to have a connector attached to an end portion thereof for fitting connection with an apparatus.

In addition, connectors to be connected to the end portion of the wiring harness, with using an insulation displacement connector has increased in recent years.

There have been proposed various types of insulation displacement connectors including a type of insulation displacement connector as described in Patent Document 1 in which insulations of electric wires are displaced individually for electric connection or a type of insulation displacement connector as described in Patent Document 2 in which insulations of electric wires are displaced collectively for electric connection.

The insulation displacement connector of the individual insulation displacement type is configured such that insulation displacement connection terminals made of conductive material are brought into press contact with ends of electric wires one by one for electric connection, and thereafter, the insulation displacement connection terminals to which the electric wires are connected are fittingly installed in a terminal accommodation portion of a connector housing made of insulating resin.

The insulation displacement connector of the collective insulation displacement type is configured such that a plurality of insulation displacement connection terminals are arranged in parallel in a housing main body which is made of insulating resin and opened at one side and a plurality of electric wires aligned on the insulation displacement connection terminals are collectively pressed into insulation displacement blades of the insulation displacement connection terminals so that the electric wires are brought into press contact with the insulation displacement connection terminals, and thereafter, the insulation displacement connection terminals are covered by a housing cover made of insulation material.

### RELATED ART DOCUMENT

Patent Document

Patent Document 1: JP-A-08-083631

Patent Document 2: JP-A-2001-135368

### SUMMARY OF THE INVENTION

Problem that the Invention is to Solve

When the above-described insulation displacement connector of Patent Document 1 is used, however, the electric wires have to be connected individually to the insulation displacement connectors one by one, and thereafter, the insulation displacement connectors to which the electric wires are connected have to be fittingly installed in the connector housing. Thus, it takes a number of labor hours to complete forming the wiring harness in which the insulation displacement connectors are connected to the end portion thereof, and it raises a problem of increasing in the fabrication cost of the wiring harness.

In addition, when the insulation displacement connector of Patent Document 2 is used, the plurality of electric wires can be connected to the insulation displacement connection terminals collectively through insulation displacement connection. Thus, compared with the connector of Patent Document 1, the number of man-hours in implementing the insulation displacement connection can be reduced. However, a large operating force is necessary to implement the collective insulation displacement connection, and a special tool needs to be prepared. Further, it is necessary to carry out the housing cover attaching work after the insulation displacement connection treatment. When considering the number of man-hours and the special tool to be prepared, with the insulation displacement connector of Patent Document 2, there also exists a problem of increasing in the fabrication cost of the wiring harness.

Thus, an object of the invention is to solve the problems described above and more particularly to provide an electric wire holder capable of facilitating an end treatment of a wiring harness by being attached to an end portion of the wiring harness in place of an insulation displacement connector to reduce the fabrication cost of the wiring harness and of increasing the reliability in the insulation displacement connection at the end portion of the wiring harness.

### Means for Solving the Problem

The object of the invention will be attained by the following configurations.

(1) An electric wire holder, comprising: a holder main body having an electric wire alignment portion which holds a plurality of electric wires constituting a wiring harness in parallel; and a holder cover joined onto the holder main body so as to cover the electric wires held in the holder main body from above so that portions of the electric wires, which are led out of the holder main body are fixedly-sandwiched between the holder main body and the holder cover, wherein the electric wire alignment portion is formed with a plurality of leading end insertion holes through which leading end portions of the electric wires are inserted so that the electric wires are positioned in parallel, and an insulation displacement blade insertion hole through which an insulation displacement blade is inserted so that the electric wires held in parallel are brought into press contact with the insulation displacement blade, and wherein each of the leading end insertion holes is formed into a tapered through hole which satisfies D2≦d<D1, where D1 denotes an inside diameter of each of the leading end insertion holes at an electric wire lead-in side, D2 denotes an inside diameter of each of the leading end insertion holes at an electric wire lead-out side, and d denotes an outside diameter of a sheathing of each of the electric wires.

(2) The electric wire holder as set forth in (1), wherein the holder cover is formed with a first fastening rib which fastens an upper end of a first holding portion in which the leading end insertion holes are formed when the holder cover is joined onto the holder main body.

(3) The electric wire holder as set forth in (1) or (2), comprising: a second holding portion provided in the electric wire alignment portion at a position where the second holding portion faces the first holding portion across the insulation displacement blade insertion hole, the second holding portion positions the electric wires in parallel with slits which individually sandwiches the electric wires from sides thereof, a first electric wire support rib erected on the holder main body so as to support back sides of the electric wires held in parallel in the electric wire alignment portion; and a second electric wire support rib erected on the holder cover, the second electric wire support rib fixedly-sandwiches the electric wires in cooperation with the first electric wire support rib when the holder cover is joined onto the holder main body so as to position the electric wires in parallel.

(4) The electric wire holder as set forth in (3), wherein each of the slits is formed into a shape which satisfies W3<W2<d<W1, where W1 denotes a groove width of each of the slits at an open end from which each of the electric wires is fitted into, W2 denotes a groove width at an electric wire support position, W3 denotes a groove width at a position between the open end and the electric wire support position, and d denotes the outside diameter of the sheathing of each of the electric wires.

According to the configuration of (1) described above, in connecting the electric wire holder to the leading end portions of the plurality of electric wires constituting the wiring harness, the leading end portions of the electric wires are inserted through the corresponding leading end insertion holes which are provided in the electric wire alignment portion of the holder main body so that the plurality of electric wires are held in parallel. Then, the holder cover is joined onto the holder main body, which completes the connection of the electric wire holder to the wiring harness.

In the connection work of the electric wire holder to the wiring harness as described above, the work of inserting the leading end portions of the electric wires into the corresponding leading end insertion holes can be carried out in an extremely easy fashion since the inside diameter of each leading end insertion hole at the electric wire lead-in side is set larger than the outside diameter of the sheathing of each electric wire, the leading end portions of the electric wires do not come into interference with opening edges of the leading end insertion holes and hence have no difficulty in being inserted into the corresponding leading end insertion holes and no large operating force is necessary. Moreover, since the inside diameter of each leading end insertion hole at the electric wire lead-out side is set equal to or smaller than the outside diameter of the sheathing of each electric wire, the leading end portions of the electric wires which are inserted into the corresponding leading end insertion holes fit tightly in corresponding opening edges of the leading end insertion holes at the electric wire lead-out side to be prevented from being dislodged therefrom (to be temporarily fastened). Consequently, there occurs no such situation that the electric wires are dislodged abruptly from the holder main body or the electric wires in the holder main body are loosened after the plurality of electric wires are held in parallel in the holder main body and before the holder cover is joined onto the holder main body. In addition, in a state where the holder cover joined onto the holder main body, the portions of the electric wires, which are led out of the holder main body are fixedly-sandwiched between the holder main body and the holder cover.

Consequently, according to the configuration of (1) described above, it is possible to hold the plurality of electric wires constituting the wiring harness in parallel with the simple operation without employing any special tool, and hence, it is possible to carry out the end treatment of the wiring harness extremely easily, in which the electric wire holder is connected to the leading end portions of the electric wires of the wiring harness.

In addition, according to the configuration of (1) described above, it is possible to attach the electric wire holder to the wiring harness with the small operating force without employing any special tool, and therefore, the electric wire holder can easily be attached to the wiring harness even in the factory floor.

In the wiring harness equipped with the electric wire holder having the configuration of (1) described above, the electric wire holder is installed on a wiring harness connecting portion of an electric apparatus to which the wiring harness is to be connected, and the insulation displacement blade of the insulation displacement connection terminals which are arranged at the wiring harness connecting portion are inserted through the insulation displacement blade insertion hole of the electric wire holder, then the electric wires in the electric wire holder are electrically connected to the insulation displacement connection terminals through insulation displacement connection.

At that time, since the electric wires within the electric wire holder are firmly fixed in the electric wire holder in such a way that the portions of the electric wires, which are led out from the holder main body are sandwiched and fixed between the holder main body and the holder cover and the leading end portions of the electric wires are tightly fitted into the leading end insertion holes, the electric wires are prevented from being pushed away from the insulation displacement blade when the insulation displacement blade is brought into press contact with the corresponding electric wires. Thus, it is possible to surely bring the insulation displacement blade into press contact with the electric wires through the insulation displacement connection.

Further, compared with the conventional insulation displacement connectors, the electric wire holder having the configuration of (1) described above involves a fewer number of parts and also has the simple construction.

Consequently, by being attached to the end portion of the wiring harness in place of an insulation displacement connector, the electric wire holder can facilitate the end treatment of the wiring harness to reduce the fabrication cost of the wiring harness and increase the reliability in the insulation displacement connection at the end portion of the wiring harness.

According to the configuration of (2) described above, a pressing force acts on the first holding portion of the holder main body from the first fastening rib when the holder cover is joined onto the holder main body. This pressing force acts in such a direction that the leading end insertion holes are compressed, and therefore, the holding force of the electric wires at the leading end insertion holes can be strengthened, thereby making it possible to increase the fixing strength of the electric wires within the electric wire holder.

In addition, when the holder cover is joined onto the holder main body, the holding force of the electric wires at the leading end insertion holes by the first fastening rib is strengthened. Thus, even if a portion of the first holding portion which lies above the leading end insertion holes is made thin in thickness so that the leading end insertion holes are easily expanded in diameter through elastic deformation when the electric wires are inserted therethrough, there occurs no such situation that the electric wire holding force at the leading end insertion holes is reduced. Consequently, the insertion of the leading end portions of the electric wires through the leading end insertion holes can be facilitated by reducing the thickness of the portion of the first holding portion which lies above the leading end insertion holes.

According to the configuration of (3) described above, the electric wires within the electric wire holder are sandwiched by the slits at the second holding portion and further sandwiched between the first electric wire support rib and the second electric wire support rib.

Since the number of the portions where the electric wires are fixed is increased, the fixing strength of the electric wires within the electric wire holder since increased.

Consequently, at the time of insulation displacement connection in which the insulation displacement blade is inserted through the insulation displacement blade, the electric wires are fixed firmly so as not to be pushed away from the insulation displacement blade. Thus, it is possible to further increase the reliability in the insulation displacement connection.

According to the configuration of (4) described above, the electric wires are made difficult to be dislodged from the slits while the operation of fitting the electric wires into the slits in the second holding portion is made easy. Consequently, not only the installation of the electric wires into the holder main body can be facilitated, but also the fixing strength of the electric wires within the electric wire holder can be increased.

### BRIEF DESCRIPTION OF THE DRAWINGS

FIG. 1 is a perspective view showing a schematic configuration of an embodiment of an electric wire holder according to the invention.

FIG. 2 is a perspective view of a state in which a holder main body and a holder cover of the electric wire holder shown in FIG. 1 are joined together.

FIG. 3 is a plan view of the state in which a holder main body and a holder cover of the electric wire holder shown in FIG. 1 are joined together.

FIGS. 4A and 4B show explanatory drawings of a specific example of an attaching construction of the electric wire holder shown in FIG. 2 to an electric apparatus, of which FIG. 4A is a side view showing a state in which the attachment is started, and FIG. 4B is a side view showing a state in which the attachment is completed.

FIG. 5 is a sectional view taken along the line A-A in FIG. 3.

FIGS. 6A and 6B show enlarged sectional views of a first holding portion of the holder main body shown in FIG. 1, of which Fig. GA is an enlarged sectional view before an electric wire is held by the first holding portion, and FIG. 6B is an enlarged sectional view after the electric wire is held by the first holding portion.

FIGS. 7A and 7B show enlarged perspective views of a second holding portion of the holder main body shown in FIG. 1, of which FIG. 7A is an enlarged perspective view before the electric wire is held by the second holding portion, and FIG. 7B is an enlarged perspective view after the electric wire is held by the second holding portion.

FIG. 8 is a sectional view showing a state in which the electric wire within the electric wire holder shown in FIG. 5 is electrically connected to an exterior insulation displacement connection terminal through insulation displacement connection.

FIG. 9 is a sectional view of an electric wire holder as a comparison example in which the first holding portion, the second holding portion and a second electric wire support rib shown in FIG. 5 are not fitted.

FIG. 10 is an explanatory drawing of a problem caused in the electric wire holder shown in FIG. 9.

### MODE FOR CARRYING OUT THE INVENTION

Hereinafter, a preferred embodiment of an electric wire holder according to the invention will be described in detail by reference to the drawings.

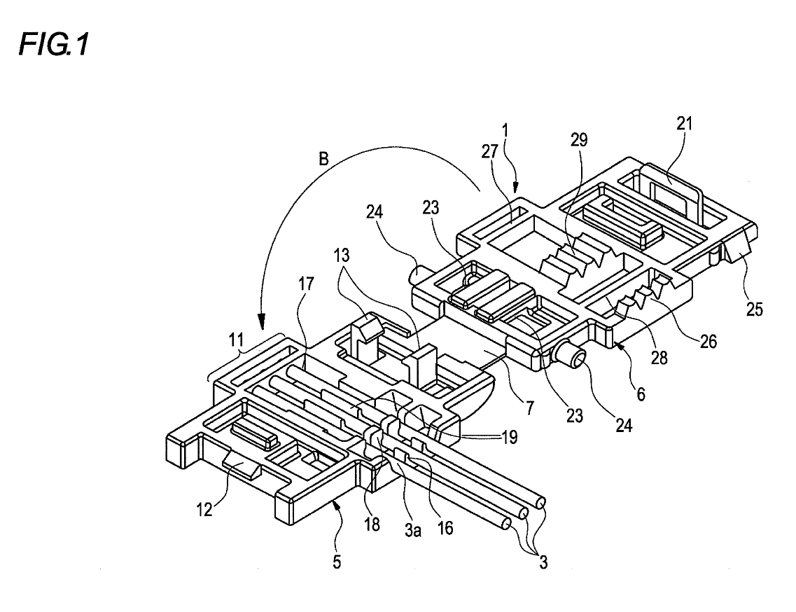

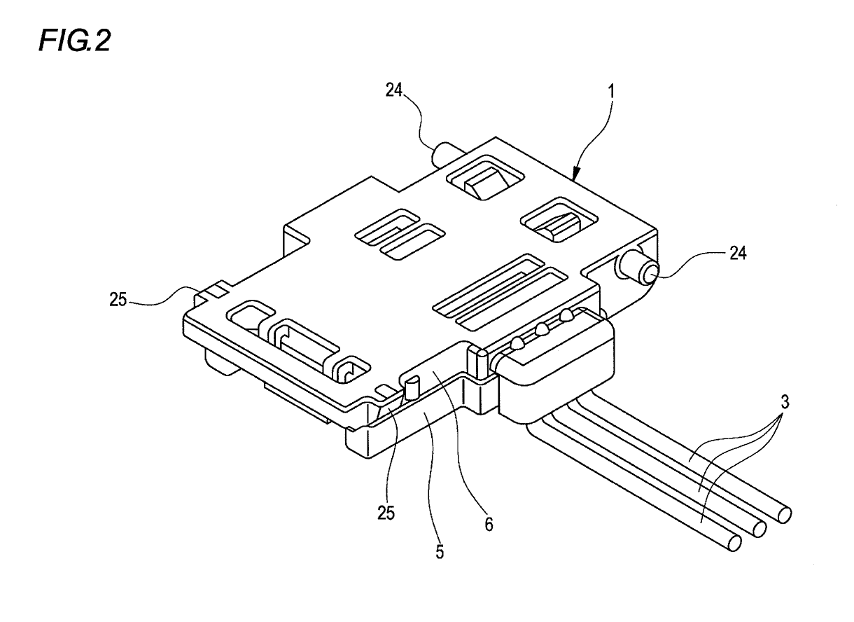

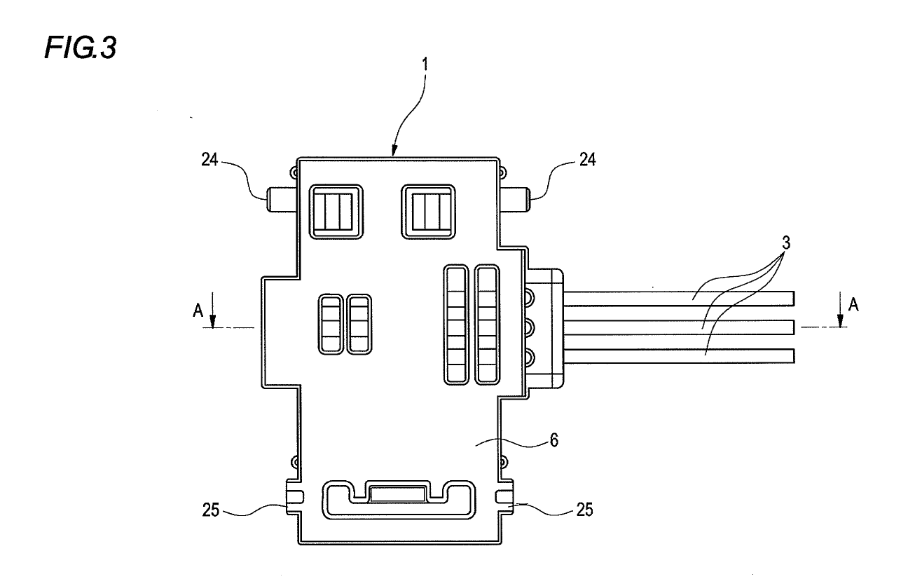

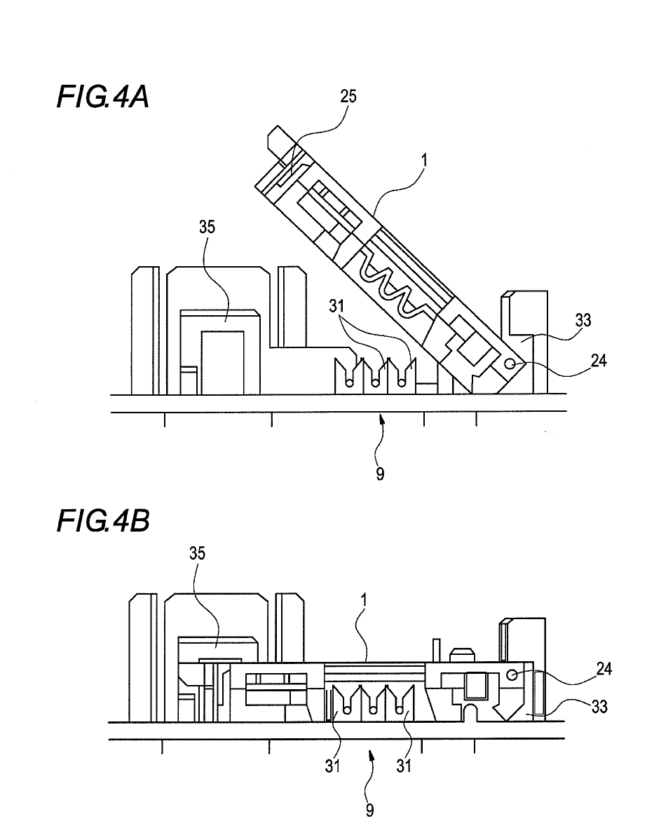

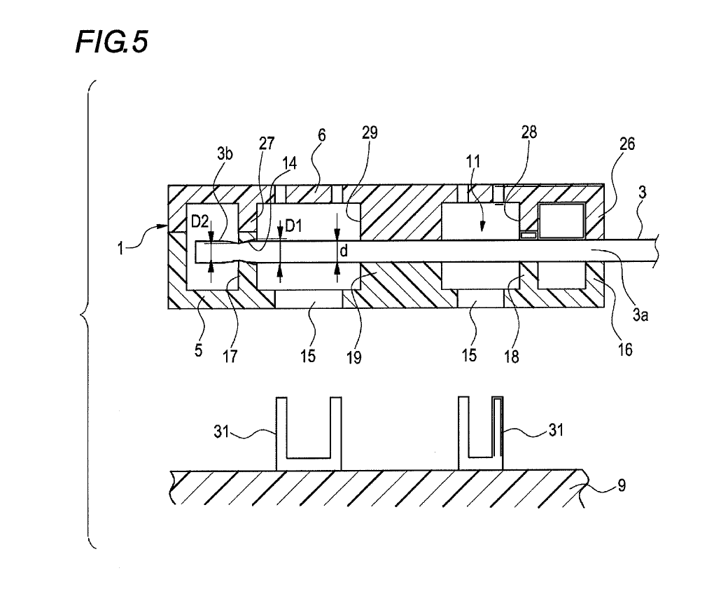

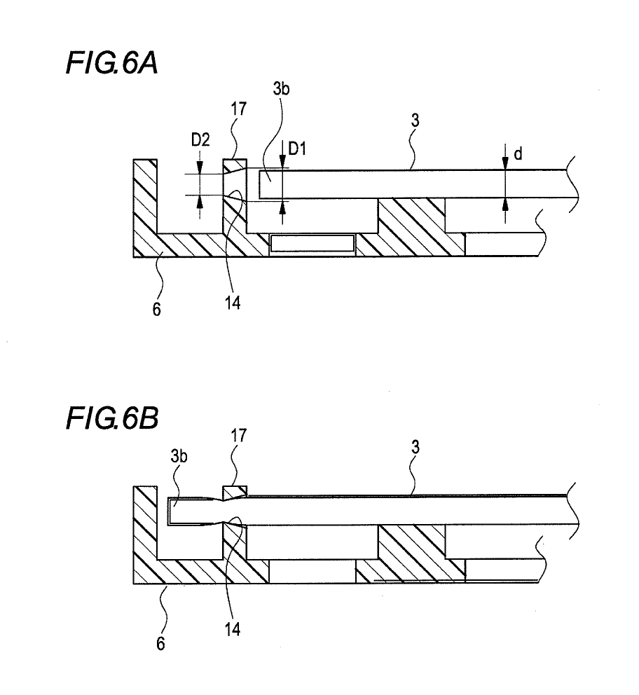

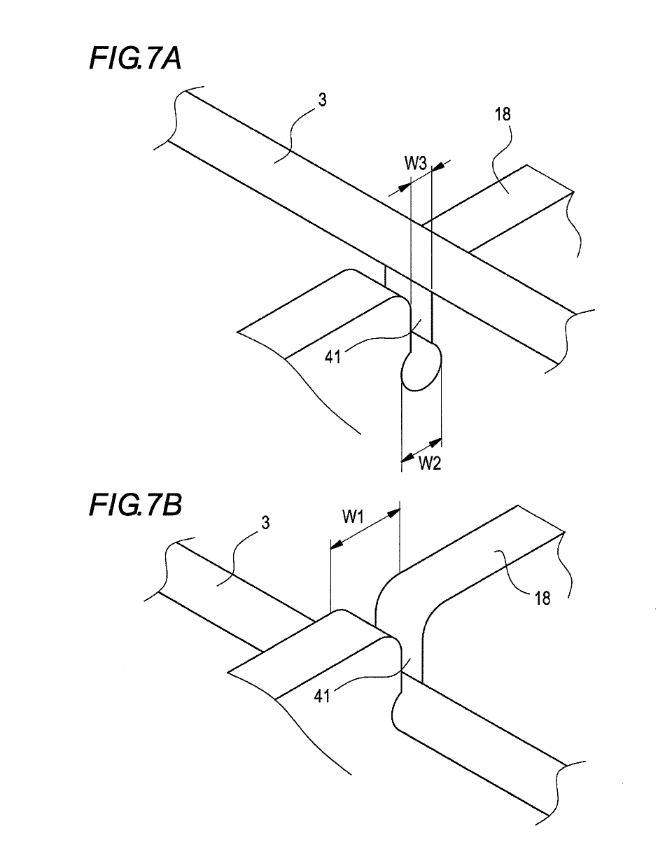

FIG. 1 is a perspective view showing a schematic configuration of an embodiment of an electric wire holder according to the invention. FIG. 2 is a perspective view of a state in which a holder main body and a holder cover of the electric wire holder shown in FIG. 1 are joined together. FIG. 3 is a plan view of the state in which a holder main body and a holder cover of the electric wire holder shown in FIG. 1 are joined together. FIGS. 4A and 4B are explanatory drawings of a specific example of an attaching construction of the electric wire holder shown in FIG. 2 to an electric apparatus, of which FIG. 4A is a side view showing a state in which the attachment is started, and FIG. 4B is a side view showing a state in which the attachment is completed. FIG. 5 is a sectional view taken along the line A-A in FIG. 3. FIGS. 6A and 6B are enlarged sectional views of a first holding portion of the holder main body shown in FIG. 1, of which FIG. 6A is an enlarged sectional view before an electric wire is held by the first holding portion, and FIG. 6B is an enlarged sectional view after the electric wire is held by the first holding portion. FIGS. 7A and 7B are enlarged perspective views of a second holding portion of the holder main body shown in FIG. 1, of which FIG. 7A is an enlarged perspective view before the electric wire is held by the second holding portion, and FIG. 7B is an enlarged perspective view after the electric wire is held by the second holding portion.

An electric wire holder 1 of this embodiment includes, as shown in FIG. 1, a holder main body 5 having an electric wire alignment portion 11 which holds a plurality of electric wires 3 constituting a wiring harness in parallel and a holder cover 6 which is formed integrally at one end side of the holder main body 5.

In addition, the holder cover 6 is connected rotatably to the one end side of the holder main body 5 via a thin hinge portion 7. An arrow B in FIG. 1 shows a rotating direction of the holder cover 6 via the thin hinge portion 7.

As shown in FIGS. 2 and 3, the holder cover 6 can be rotated about the thin hinge portion 7 as a fulcrum so as to be placed over the holder main body 5 to thereby be joined to the holder main body 5.

To lock the holder main body 5 and the holder cover 6 together in such a joined state, on the holder main body 5, a locking projection 12 is formed integrally at the other end side, and further, elastic locking pieces 13 are formed integrally in positions closer to the one end (closer to the thin hinge portion 7) so as to extend upwards therefrom.

In addition, on the holder cover 6, an elastic lock piece 21 is formed integrally at an end portion which is superposed on the other end portion of the holder main body 5 when the holder cover 6 is placed over the holder main body 5 for engagement with the locking projection 12. Further, connecting recess portions 23 are formed in portions of the holder cover 6 which lie closer to the thin hinge portion 7 for engagement with the elastic locking pieces 13.

Further, in the case of the electric wire holder of this embodiment, attaching shaft portions 24 are provided on both external surfaces of the holder cover 6 in positions lying closer to the thin hinge portion 7 so as to project therefrom. In addition, attaching engagement portions 25 are provided on both the external surfaces of the holder cover 6 in positions lying closer to the elastic lock piece 21 so as to project therefrom.

As shown in FIGS. 4A and 4B, these attaching shaft portions 24 and attaching engagement portions 25 are portions which are locked on the side of a wiring harness connecting portion 9 when the electric wire holder 1 is fixed to the wiring harness connecting portion 9 of an electric apparatus. Insulation displacement blades 31 of insulation displacement connection terminals are arranged at the wiring harness connecting portion 9 to which the electric wires 3 within the electric wire holder 1 are to be electrically connected through insulation displacement connection.

As shown in FIG. 4A, the attaching shaft portions 24 of the electric wire holder 1 are rotatably supported by shaft support portions 33 which are fitted on the wiring harness connecting portion 9. As shown in FIG. 4B, the attaching engagement portions 25 are rotated about the attaching shaft portions 24 as fulcrums so as to be brought into engagement with lock portions 35 fitted on the wiring harness portion 9 when the insulation displace connection by the insulation displacement blades 31 is completed, whereby the electric wire holder 1 is fixed to the wiring harness connecting portion 9.

The holder cover 6 of the electric wire holder 1 of this embodiment fixedly holds portions of the electric wires 3 which are let out from the holder main body 5 (hereinafter, referred to as led-out portions) between the holder main body 5 and itself as shown in FIG. 5 in such a state that the holder cover 6 is joined onto the holder main body 5 as shown in FIGS. 2 and 3.

Further, in such a state that it is joined onto the holder main body 5 as shown in FIGS. 2 and 3, the holder cover 6 holds portions 3a of the electric wires 3 which are led out from the holder main body 5 (hereinafter, referred to as led-out portions) between the holder main body 5 and itself as shown in FIG. 5.

In FIG. 5, reference numeral 16 denotes a holding wall portion of the holder main body 5 which comes into abutment with the led-out portions 3a from therebelow. In addition, reference numeral 26 denotes a holding wall portion on the side of the holder cover 6 which comes into abutment with the led-out portions 3a from above to hold them between the holding wall portion 16 and itself.

The electric wire alignment portion 11 of the holder main body 5 in this embodiment includes, as shown in FIG. 5, a plurality of leading end insertion holes 14, insulation displacement blade insertion holes 15, a second holding portion 18 and a first electric wire support rib 19.

In addition, the holder cover 6 includes a first fastening rib 27 which corresponds to a first holding portion 17, a second fastening rib 28 which corresponds to the second holding portion 18 and a second electric wire support rib 29 which corresponds to the first electric wire support rib 19.

The plurality of leading end insertion holes 14 are formed in the first holding portion 17 which is erected in a rib-like fashion on the holder main body 5 so as to penetrate therethrough in parallel at constant intervals. The plurality of leading end insertion holes 14 allow leading end portions 3b of the corresponding electric wires to be inserted therethrough and position the plurality of electric wires 3 in parallel.

In the case of this embodiment, as shown in FIG. 6A, the leading end insertion hole 14 is formed into a tapered through hole which satisfies D2≦d<D1, where D1 denotes an inside diameter of each of the leading end insertion holes 14 at an electric wire lead-in side, D2 denotes an inside diameter of each of the leading end insertion holes at an electric wire lead-out side, and d denotes an outside diameter of a sheathing of each of the electric wires.

The insulation displacement blade insertion holes 15 are openings which enable the insulation displacement blades 31 on the exterior insulation displacement connection terminals to be inserted therethrough for insulation displacement connection with the electric wires 3 held in parallel within the electric wire holder 1.

The second holding portion 18 is provided in a rib-like fashion in the electric wire alignment portion 11 at a position where the second holding portion 18 faces the first holding portion 17 across the insulation displacement blade insertion holes 15.

As shown in FIGS. 7A and 7B, this second holding portion 18 positions the plurality of electric wires 3 in parallel by means of a plurality of slits 41 which individually sandwich the corresponding electric wires from sides thereof

As shown in FIGS. 7A and 7B, each slit 41 is formed into a shape which satisfies W3<W2<d<W1, where W1 denotes a groove width of each slit 41 at an open end from which each electric wire is fitted into, W2 denotes a groove width in an electric wire supporting position (a terminating end), W3 denotes a groove width at a position between the open end and the electric wire supporting position, and d denotes the outside diameter of the sheathing of each electric wire 3.

As shown in FIG. 5, the first electric wire support rib 19 is erected on the holder main body 5 so as to support back sides of the electric wires which are held in parallel in the electric wire alignment portion.

The first fastening rib 27 is erected on the holder cover 6 and fastens an upper end of the first holding portion 17 in which the leading end insertion holes 14 are formed as shown in FIG. 5 when the holder cover 6 is joined onto the holder main body 5.

The second fastening rib 28 is erected on the holder cover 6 and fastens an upper end of the second holding portion 18 in which the slits 41 are formed so as to close the open ends of the slits 41 as shown in FIG. 5 when the holder cover 6 is joined onto the holder main body 5.

The second electric wire support rib 29 is erected on the holder cover 6 and fixedly sandwiches the electric wires 3 from above and below in cooperation with the first electric wire support rib 19 as shown in FIG. 5 when the holder cover 6 is joined onto the holder main body 5 so as to position the plurality of electric wires 3 in parallel.

In the electric wire holder 1 of the embodiment that has been described heretofore, in connecting the electric wire holder 1 to the leading end portions 3b of the plurality of electric wires which make up the wiring harness, firstly, as shown in FIGS. 6A and 6B, the leading end portions 3b of the electric wires are inserted through the corresponding leading end insertion holes 14 formed in the electric wire alignment portion 11 of the holder main body 5, so that the plurality of electric wires 3 are temporarily fastened while being held in parallel by the leading end insertion holes 14.

Following this, as shown in FIGS. 7A and 7B, the covered electric wires 3 which are being temporarily fastened are fitted into the corresponding slits 41 in the second holding portion 18, so that the covered electric wires 3 are held in parallel in the electric wire alignment portion 11 by the leading end insertion holes 14 and the slits 41.

Following this, joining the holder cover 6 onto the holder main body 5 as shown in FIG. 5 completes the connection of the electric holder to the wiring harness.

Then, in the connection work of the electric wire holder 1 to the wiring harness, the work of inserting the leading end portions 3b of the electric wires through the corresponding leading end insertion holes 14 can be carried out in an extremely easy fashion since due to the inside diameter D1 of each of the leading end insertion holes 14 at the electric wire lead-in side being set larger than the outside diameter d of each of the sheathings of the electric wires 3, the leading end portions of the electric wires do not come into interference with opening edges of the leading end insertion holes 14 and hence have no difficulty in being inserted through the corresponding leading end insertion holes 14 and no large operating force is necessary. Moreover, since the inside diameter D2 of each of the leading end insertion holes 14 at the electric wire lead-out side is set equal to or smaller than the outside diameter d of each of the sheathings of the electric wires 3, the leading end portions 3b of the electric wires which are inserted through the corresponding leading end insertion holes 14 fit tightly in corresponding opening edges of the leading end insertion holes 14 at the electric wire lead-out side to be prevented from being dislodged therefrom (to be temporarily fastened). Consequently, there occurs no such situation that the electric wires 3 are dislodged abruptly from the holder main body 5 or the electric wires 3 in the holder main body 5 are loosened while the electric wires 3 are fitted into the slits 41 or the holder cover 6 is joined onto the holder main body 5 after the plurality of electric wires 3 are held in parallel in the holder main body 5. In addition, with the holder cover 6 joined onto the holder main body 5, the led-out portions 3a of the electric wires 3 are fixedly held between the holder main body 5 and the holder cover 6.

Consequently, according to the electric wire holder 1 of the embodiment that has been described heretofore, the state in which the plurality of electric wires 3 which make up the wiring harness are held in parallel can be obtained with the simple operation without employing any special tool, and hence, the end treatment of the wiring harness can be carried out extremely easily in which the electric wire holder 1 is connected to the leading end portions 3b of the electric wires of the wiring harness.

In addition, in the electric wire holder 1 of the embodiment that has been described heretofore, the electric wire holder 1 can be attached to the wiring harness with the small operating force without employing any special tool, and therefore, the electric wire holder 1 can easily be attached to a wiring harness even in the factory floor.

Then, in the wiring harness to which the electric wire holder 1 of the embodiment that has been described heretofore is fitted, as shown in FIGS. 4A and 4B, the electric wire holder 1 is installed in the wiring harness connecting portion 9 of the electric apparatus to which the wiring harness is to be connected, and the insulation displacement blades 31 of insulation displacement connection terminals which are disposed at the wiring harness connecting portion 9 are inserted through the insulation displacement blade insertion holes 15 in the electric wire holder 1, whereby the electric wires 3 in the electric wire holder 1 are electrically connected to the insulation displacement connection terminals through insulation displacement connection.

As this occurs, in the electric wires 3 within the electric wire holder 1, the led-out portions 3a from the holder main body 5 are fixed in place by being held by the holder main body 5 and the holder cover 6 therebetween, and the leading end portions 3b of the electric wires are tightly fitted in the leading end insertion holes 14. Further, in the electric wire holder 1 of the embodiment, the electric wires 3 in the electric wire holder 1 are fixed by being held from the sides thereof by the slits 41 and are also fixed by being held from therebelow and thereabove by the first electric wire support rib 19 and the second electric wire support rib 29. Thus, the electric wires 3 are fixed firmly within the electric wire holder 1.

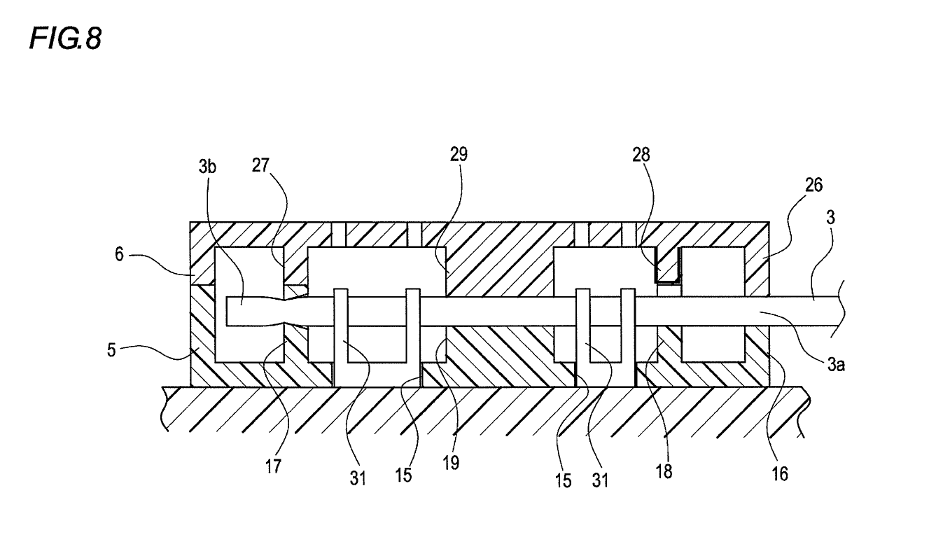

Because of this, when the insulation displacement blades 31 are brought into press contact with the corresponding electric wires 3, the electric wires 3 are prevented from being pushed away from the insulation displacement blades 31, whereby the insulation displacement blades 31 can be brought into press contact with the electric wires 3 through insulation displacement connection in an ensured fashion as is shown in FIG. 8.

Further, in the electric wire holder 1 of the embodiment that has been described heretofore, compared with the conventional insulation displacement connectors, the electric wire holder 1 involves a fewer number of parts and also has the simple construction.

Consequently, by being fitted to the end portion of the wiring harness in place of an insulation displacement connector, the electric wire holder 1 can facilitate the end treatment of the wiring harness, reduce the wiring harness fabrication cost and increase the reliability of insulation displacement connection at the end portion of the wiring harness.

In addition, in the case of the electric wire holder 1 of the embodiment that has been described heretofore, the holder cover 6 includes the first fastening rib 27 which fastens the upper end of the first holding portion 17 in which the leading end insertion holes 14 are formed when the holder cover 6 is joined onto the holder main body 5.

Because of this, a pressing force acts on the first holding portion 17 of the holder main body 5 from the first fastening rib 27 in such a state that the holder cover 6 is joined onto the holder main body 5. This pressing force acts in such a direction that the leading end insertion holes 14 are compressed, and therefore, the holding force of the electric wires at the leading end insertion holes 14 can be strengthened, thereby making it possible to increase the fixing strength of the electric wires within the electric wire holder 1.

In addition, when the holder cover 6 is joined onto the holder main body 5, the holding force of the electric wires 3 at the leading end insertion holes 14 is strengthened by the first fastening rib 27. Thus, even in the event that a portion of the first holding portion 17 which lies above the leading end insertion holes 14 is made thin in thickness so that the leading end insertion holes 14 are easily expanded in diameter through elastic deformation when the electric wires 3 are inserted therethrough, there occurs no such situation that the electric wire holding performance of the leading end insertion holes 14 is reduced. Consequently, the insertion of the leading end portions 3b of the electric wires through the leading end insertion holes 14 can be facilitated by reducing the thickness of the portion of the first holding portion 17 which lies above the leading end insertion holes 14.

In addition, in the case of the electric wire holder 1 of the embodiment that has been described heretofore, the electric wire holder 1 includes the second holding portion 18 which is provided in the electric wire alignment portion 11 at the position where the second holding portion 18 faces the first holding portion 17 across the insulation displacement blade insertion holes 15 for positioning the plurality of electric wires 3 in parallel by means of the slits 41 which sandwiches individually the electric wires from the sides thereof, the first electric wire support rib 19 which is erected on the holder main body 5 so as to support the back sides of the electric wires 3 held in parallel in the electric wire alignment portion 11, and the second electric wire support rib 29 which is erected on the holder cover 6, the second electric wire support rib 29 fixedly-sandwiches the electric wires 3 in coopration with the first electric wire support rib 19 when the holder cover 6 is joined onto the holder main body 5 to position the electric wires 3 in parallel.

Because of this, compared with a case where the fixing of the electric wires 3 within the electric wire holder 1 is limited to the two locations where the led-out portions 3b of the electric wires 3 are held by the holding wall portion 16 and the holding wall portion 26 therebetween and where the leading end portions 3b of the electric wires 3 fit tightly in the leading end insertion holes 14, the fixing strength of the electric wires within the electric wire holder 1 is very high as a result of the increase in the number of electric wire fixing locations within the electric wire holder 1.

Consequently, at the time of insulation displacement connection when the insulation displacement blades 31 are inserted through the insulation displacement blade insertion holes 15 for press contact with the electric wires 3, the electric wires 3 are fixed so firmly as not to be pushed away from the insulation displacement blades 31, thereby making it possible to increase the reliability in insulation displacement connection.

In the case of the electric wire holder 1 of the embodiment that has been described heretofore, each slit 41 is formed into the shape which satisfies W3<W2<d<W1, where W1 denotes the groove width of each slit 41 at an open end from which each electric wire 3 is fitted into, W2 denotes the groove width at an electric wire supporting position (a terminating end), W3 denotes the groove width at a position between the open end and the electric wire supporting position, and d denotes the outside diameter of the sheathing of each electric wire 3.

Because of this, the electric wires 3 are made difficult to be dislodged from the slits 41 while the operation is made easy of forcing the electric wires into the slits 41 in the second holding portion 18. Consequently, not only can the installation of the electric wires into the holder main body 5 be facilitated, but also the fixing strength of the electric wires within the electric wire holder 1 can be increased.

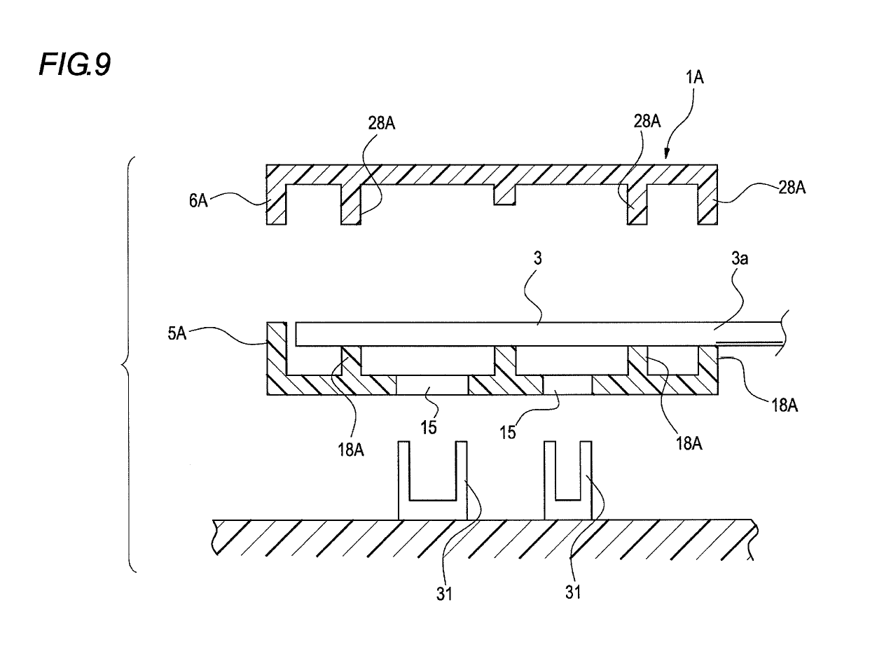

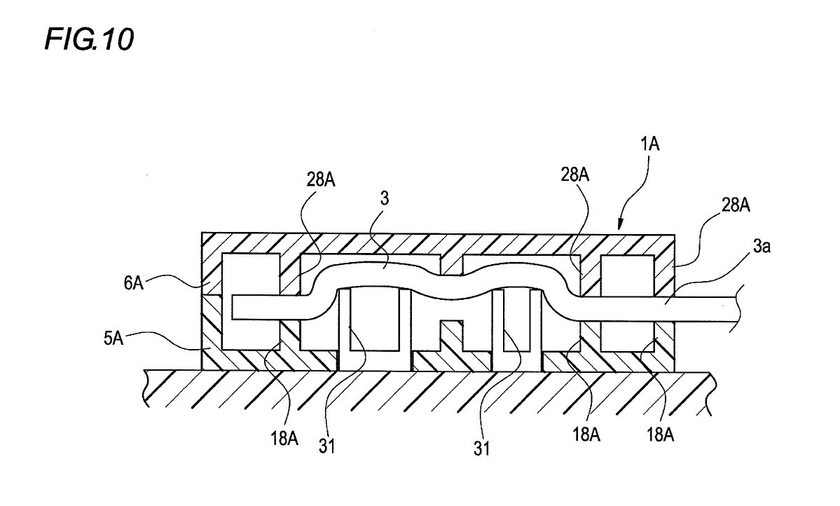

FIG. 9 shows the configuration of an electric wire holder 1A as a comparison example, and FIG. 10 shows a state after an insulation displacement connection has been carried out in the electric wire holder 1A.

In the electric wire holder 1A shown in FIG. 9, when compared with the electric wire holder 1 of the embodiment, the leading end insertion holes 14 and the slits 41 which are shown in the embodiment are not fitted in a holder main body 5A. This holder main body 5A and a holder cover 6A of the comparison example include fastening ribs 18A, 28A at a plurality of locations which confront each other. These fastening ribs 18A, 28A hold electric wires 3 from therebelow and thereabove so as to fixedly hold the electric wires 3.

In the electric wire holder 1A constructed in the way described above, however, the electric wires 3 on the holder main body 5A are loosened in the midst of the holder cover 6 being joined onto the holder main body 5A, and when an insulation displacement connecting operation is performed, the electric wires 3 are pushed away from insulation displacement blades 31 as is shown in FIG. 10, leading to fears that an insulation displacement connection failure occurs. In addition, since the fixing strength of the electric wires 3 within the electric wire holder 1A, the electric wires 3 are moved by virtue of pressing forces exerted by the insulation displacement blades 31, leading to fears that an insulation displacement connection failure occurs.

The problem inherent in this comparison example that the electric wires 3 are loosened within the electric wire holder 1A while the holder cover 6A is being joined onto the holder main body 5A can be solved in case the electric wire holder 1A includes the leading end insertion holes 14 and the holding wall portion 16 and the holding wall portion 26 according to the invention, the holding wall portion 16 and the holding wall portion 26 cooperating in holding the led-out portions 3a of the electric wires 3.

Namely, the electric wires within the electric wire holder are not loosened when the holder cover 6 is joined onto the holder main body 5 while exerting on the electric wires 3 a tension which holds the electric wires 3 in a stretched condition in such a state that the leading end portions 3b of the electric wires 3 are held in the leading end insertion holes 14. Because of this, the occurrence of an insulation displacement connection failure attributed to the looseness being produced in the electric wires within the electric wire holder can be prevented.

Consequently, it is considered that the electric wire holder according to the invention is provided with a simpler construction from which omitted are the first fastening rib and the second holding portion where the plurality of electric wires are positioned in parallel by the slits.

The invention is not limited to the embodiment that has been described above but can be modified or improved freely as required. In addition, the material, shapes, dimensions, numeric values, forms, numbers, disposing locations of the individual constituent elements are arbitrary and are not limited thereto described in the embodiment, provided that the invention can be attained by them.

For example, the shape of the leading end insertion hole 14 is not limited to the circular shape described in the embodiment and hence may be rectangular. In this case, a portion lying above the holes so formed may be made thin in thickness so that the leading end insertion holes are easily deformed.

While the invention has been described in detail and by reference to the specific embodiment, it is obvious to those skilled in the art to which the invention pertains that various alterations or modifications can be made thereto without departing from the spirit and scope of the invention.

This patent application is based on Japanese Patent Application (No. 2009-273398) filed on Dec. 1, 2009, the contents of which are to be incorporated herein by reference.

### INDUSTRIAL APPLICABILITY

According to the electric wire holder of the invention, compared with the conventional insulation displacement connectors, the electric wire holder involves a fewer number of parts and also has the simple construction. In addition, the electric wire holder can simply be attached to the wiring harness with the small operating force.

Moreover, the electric wires within the electric wire holder can be fixed in place firmly by fitting the leading end portions of the electric wires tightly in the leading end insertion holes and further holding the led-out portions of the electric wires from the holder main body by the holder main body and the holder cover therebetween. Because of this, when the insulation displacement blades of the insulation displacement connection terminals fitted to the wiring harness connecting portion of the electric apparatus to which the wiring harness is to be connected are inserted through the insulation displacement blade insertion holes, there is caused no such situation that the electric wires are pushed away from the insulation displacement blades due to looseness being produced in the electric wires, whereby the electric wires can be brought into press contact with the insulation displacement blades through insulation displacement connection.

Consequently, by being attached to the end portion of the wiring harness in place of a conventional insulation displacement connector, the electric wire holder of the invention can facilitate the end treatment of the wiring harness to thereby reduce the wiring harness fabrication cost and can increase the reliability in ensuring the insulation displacement connection at the end of the wiring harness.

### DESCRIPTION OF REFERENCE NUMERALS AND CHARACTERS

1: electric wire holder;

3: electric wire;

3a: portions led out (led-out portion);

3b: leading end portion of electric wire;

5: holder main body; 6 holder cover;

7: thin hinge portion;

9: wiring harness connecting portion;

11: electric wire alignment portion;

14: leading end insertion hole;

15: insulation displacement blade insertion hole;

16: holding wall portion;

17: first holding portion;

18: second holding portion;

19: first electric wire support rib;

24: attaching shaft portion;

25: attaching engagement portion;

26: holding wall portion;

27: first fastening rib;

28: second fastening rib;

29: second electric wire support rib;

31: insulation displacement blade;

35: lock portion;

41: slit;

D1: inside diameter of leading end insulation hole at electric wire lead-in side;

D2: inside diameter of leading end insulation hole at electric wire lead-out side;

d: outside diameter of sheathing of electric wire;

W1: groove width of slit at open end;

W2: groove width of slit at electric wire support position; and

W3: groove width of slit at position between open end and electric wire support position.

1. An electric wire holder, comprising:
a holder main body having an electric wire alignment portion which holds a plurality of electric wires constituting a wiring harness in parallel; and
a holder cover joined onto the holder main body so as to cover the electric wires held in the holder main body from above so that portions of the electric wires, which are led out of the holder main body are fixedly-sandwiched between the holder main body and the holder cover,
wherein the electric wire alignment portion is formed with a plurality of leading end insertion holes through which leading end portions of the electric wires are inserted so that the electric wires are positioned in parallel, and an insulation displacement blade insertion hole through which an insulation displacement blade is inserted so that the electric wires held in parallel are brought into press contact with the insulation displacement blade, and
wherein each of the leading end insertion holes is formed into a tapered through hole which satisfies D2≦d<D1, where D1 denotes an inside diameter of each of the leading end insertion holes at an electric wire lead-in side, D2 denotes an inside diameter of each of the leading end insertion holes at an electric wire lead-out side, and d denotes an outside diameter of a sheathing of each of the electric wires.

2. The electric wire holder as set forth in claim 1, wherein the holder cover is formed with a first fastening rib which fastens an upper end of a first holding portion in which the leading end insertion holes are formed when the holder cover is joined onto the holder main body.

3. The electric wire holder as set forth in claim 1, comprising:
a second holding portion provided in the electric wire alignment portion at a position where the second holding portion faces the first holding portion across the insulation displacement blade insertion hole, the second holding portion positions the electric wires in parallel with slits which individually sandwiches the electric wires from sides thereof;
a first electric wire support rib erected on the holder main body so as to support back sides of the electric wires held in parallel in the electric wire alignment portion; and
a second electric wire support rib erected on the holder cover, the second electric wire support rib fixedly-sandwiches the electric wires in cooperation with the first electric wire support rib when the holder cover is joined onto the holder main body so as to position the electric wires in parallel.

4. The electric wire holder as set forth in claim 3, wherein each of the slits is formed into a shape which satisfies W3<W2<d<W1, where W1 denotes a groove width of each of the slits at an open end from which each of the electric wires is fitted into, W2 denotes a groove width at an electric wire support position, W3 denotes a groove width at a position between the open end and the electric wire support position, and d denotes the outside diameter of the sheathing of each of the electric wires.
